(19) United States
(12) Patent Application Publication
(10) Pub. No.: US 2014/0046938 A1
(43) Pub. Date: Feb. 13, 2014

(54) HISTORY RECORDS SORTING METHOD AND APPARATUS

(71) Applicant: Tencent Technology (Shen Zhen) Company Limited, Shenzhen City (CN)

(72) Inventor: Fajing LI, Shenzhen City (CN)

(73) Assignee: Tencent Technology (Shen Zhen) Company Limited, Shenzen City (CN)

(21) Appl. No.: 14/058,353

(22) Filed: Oct. 21, 2013

Related U.S. Application Data
(63) Continuation of application No. PCT/CN2012/076904, filed on Jun. 14, 2012.

(30) Foreign Application Priority Data
Nov. 1, 2011 (CN) 201110340046.4

(51) Int. Cl. G06F 17/30

(52) U.S. Cl. CPC G06F 17/30876
USPC 707/727

(57) ABSTRACT

Disclosed are a history records sorting method and apparatus, belonging to the field of network data processing. The method comprises: receiving a URL sent by a web browser and acquiring a URL type according to the URL (101); notifying the URL type to the web browser so as to cause the web browser to classify and rank the history record corresponding to the URL in terms of the URL type (102). The present technical solution acquires the URL type according to the URL and notifies the URL type to the web browser so as to cause the web browser to classify and rank the history records corresponding to the URLs, thereby improving the speed for searching for history records and making it possible to find the URL to be accessed within a short time, thus saving time for the user and making it convenient for use by the user.

### PRIORITY DECLARATION

The present application is a continuation of International Patent Application No. PCT/CN2012/076904, filed on Jun. 14, 2012, which claims priority to Chinese Patent Application No. 201110340046.4, with a title of “HISTORY RECORDS SORTING METHOD AND APPARATUS,” filed on Nov. 1, 2011, the disclosures of which are herein incorporated by reference.

### TECHNICAL FIELD

The present disclosure relates to a field of network data processing, and particularly, to a history records sorting method and apparatus as well as a history records classifying and ranking method and apparatus.

### BACKGROUND

With the development of Internet technology, a user needs more and more Internet information, and browses more and more webpages. In order to facilitate a customer to access webpages, existing web browser has been developed a function for recording history records of web sites accessed by a user recently. In order to make it convenient for a customer to find a desired web site in a short time, it is necessary to sort the history records recorded by the web browser.

A method for sorting history records recorded by a web browser is provided in the prior art. In the method, the web browser makes statistics for time lengths and/or access frequencies of respective web sites within a preset time, and ranks URLs (Uniform Resource Locator) corresponding to respective web sites based on the access time lengths and/or access frequencies.

During the implementation of the present disclosure, the inventor found out that the prior art has at least the problems as follows.

The prior art takes the access time length and/or access frequency as the basis for sorting, accordingly the URL corresponding to a web site with a shorter access time length or a lower access frequency will fall behind others, and thus the user can not find quickly the URL corresponding to the web site with the shorter access time length or the lower access frequency in a short time. In some cases, the URL corresponding to the web site with the shorter access time length or the lower access frequency may not be displayed due to the display interface of the web browser having a limited size, and the user may even fails to find the URL corresponding to the web site with the shorter access time length or the lower access frequency.

### SUMMARY

In order to improve the speed for searching for a history record, an embodiment of the present disclosure provides a history records sorting method and apparatus, as well as a history records classifying and ranking method and apparatus. The technical solutions are as follows.

In one aspect, there is provided a history records sorting method, comprising: receiving a URL sent by a web browser and acquiring a URL type according to the URL; notifying the URL type to the web browser so as to cause the web browser to classify and rank a history record corresponding to the URL in terms of the URL type.

Specifically, acquiring a URL type according to the URL comprises: analyzing webpage content of the URL and matching the webpage content with URL types in a preset type list; if a URL type in the preset type list matches with the webpage content, determining the URL type in the preset type list as the URL type of the URL; and if none of URL types in the preset type list match the webpage content, setting a new URL type according to the webpage content and taking the new URL type as the URL type of the URL.

Further, before acquiring a URL type according to the URL, the method further comprises predefining URL types according to webpage contents of commonly used URLs to obtain the preset type list; sending the preset type list to the web browser so as to cause the web browser to synchronize with the preset type list.

Each URL type in the preset type list corresponds to a respective type code.

Said notifying the URL type to the web browser comprises notifying the type code of the URL type to the web browser.

Further, after setting a new URL type according to the webpage content of the URL, the method further comprises: adding the new URL type to the preset type list to obtain an updated type list; and sending the updated type list to the web browser so as to cause the web browser to synchronize with the updated type list.

In another aspect, there is provided a history records sorting apparatus, comprising: a reception module configured to receive a URL sent by a web browser; an acquisition module configured to acquire a URL type according to the URL received by the reception module; and a notification module configured to notify the URL type acquired by the acquisition module to the web browser so as to cause the web browser to classify and rank the history record corresponding to the URL in terms of the URL type.

Specifically, the acquisition module comprises: a analyzing unit configured to analyze webpage content of the URL according to the URL received by the reception module; a matching unit configured to match the webpage content analyzed by the analyzing unit with URL types in a preset type list; a first processing unit configured to, if the matching unit derives that a URL type in the preset type list matches the webpage content analyzed by the analyzing unit, determine the URL type in the preset type list as the URL type of the URL; and a second processing unit configured to, if the matching unit derives that none of URL types in the preset type list match the webpage content analyzed by the analyzing unit, set a new URL type according to the webpage content and take the new URL type as the URL type of the URL.

Further, the apparatus further comprises a definition module configured to predefine URL types according to webpage contents of commonly used URLs to obtain the preset type list, and the notification module is further configured to send the preset type list obtained by the definition module to the web browser so as to cause the web browser to synchronize with and store the preset type list.

Each URL type in the preset type list corresponds to a respective type code.

The notification module is configured to notify the type code of the URL type to the web browser.

Further, the acquisition module further comprises an adding unit configured to add the new URL type set by the second processing unit to the preset type list to obtain a updated type list, and the notification module is further configured to send the updated type list obtained by the adding unit to the web browser so as to cause the web browser to synchronize with the updated type list.

The technical solutions provided by embodiments of the present disclosure have advantageous effects as follows.

The speed for searching for history records is improved by acquiring a URL type according to a URL and notifying the URL type to a web browser so as to cause the web browser to classify and rank the history record corresponding to the URL in terms of the URL type, and thus it is possible to find quickly the URL to be accessed within a short time, accordingly saving time for the user and making it convenient for use by the user.

In another aspect, there is provided a method for classifying and ranking a history record, comprising: recording history records pertaining to a same URL type under one director, according to the URL types of URLs corresponding to respective history records; ranking the history records under one director according to access time lengths and/or access frequencies of respective web sites corresponding to the history records within a preset time.

In another aspect, there is provided a apparatus for classifying and ranking a history record, comprising: a classifying module configured to record history records pertaining to a same URL type under one director, according to the URL types of the URLs corresponding to respective history records; a ranking module configured to rank the history records under one director according to access time lengths and/or access frequencies of respective web sites corresponding to the history records within a preset time.

The above descriptions are only an outline of the technical solution of the present disclosure. In order to make the technical means of the present disclosure more clear so as to implement it according to the content of the specification, as well as make the above and other objects, features and advantages of the present disclosure more apparent and easy to be understood, a detailed description will be given by way of embodiments in conjunction with attached drawings as follows.

### BRIEF DESCRIPTION OF THE DRAWINGS

FIG. 1 is a flowchart for a history records sorting method provided by embodiment one of the present disclosure.

FIG. 2 is a flowchart for a history records sorting method provided by embodiment two of the present disclosure.

FIG. 3 is a structural schematic diagram for a history records sorting apparatus provided by embodiment three of the present disclosure.

FIG. 4 is a structural schematic diagram for an acquisition module provided by embodiment three of the present disclosure.

FIG. 5 is a structural schematic diagram for another history records sorting apparatus provided by embodiment three of the present disclosure.

FIG. 6 is a structural schematic diagram for another acquisition module provided by embodiment three of the present disclosure.

### DETAILED DESCRIPTION

In order to further set forth the technical means adopted for achieving a predetermined object of the present disclosure and effects thereof, specific implementations, structures, features and effects of a history records sorting method and apparatus according to the present disclosure will be described in details in conjunction with attached drawings and preferred embodiments as follows.

The above and other technical contents, characteristics and effects of the present disclosure will be presented clearly in the following detailed description of preferred embodiments in conjunction with reference figures. With the description of specific embodiments, the technical means adopted for achieving the predetermined object of the present disclosure and effects thereof may be understood more thoughtfully and specifically. However, the attached figures are provided for reference and explanation only, and not for limiting of the present disclosure.

### Embodiment One

The embodiment of the present disclosure provides a history records sorting method. Referring to FIG. 1, the flow of the history records sorting method provided by the embodiment of the present disclosure comprises the following steps performed by a terminal device, such as a portable computer, a smart phone, and so on.

At step 101, receive a uniform resource locator (URL) sent by a web browser, and acquire a URL type according to the URL. The URL type indicates a type of the webpage content of the URL, such as novel, music, news, and so on.

At step 102, notify the URL type to the web browser, so as to cause the web browser to classify and rank a history record corresponding to the URL in terms of the URL type.

Specifically, acquiring a URL type according to the URL includes steps of: analyzing webpage content of the URL and matching the webpage content with URL types in a preset type list; if a URL type in the preset type list matches with the webpage content, determining the URL type in the preset type list as the URL type of the URL; and if none of the URL types in the preset type list match with the webpage content of the URL, setting a new URL type according to the webpage content and taking the new URL type as the URL type of the URL.

Further, before acquiring the URL type according the URL, the method further includes steps of: predefining the URL types according to webpage contents of commonly used URLs to obtain the preset type list; sending the preset type list to the web browser so as to cause the web browser to synchronize with and store the preset type list.

Each URL type in the preset type list corresponds to a respective type code.

Notifying the URL type to the web browser includes a step of notifying the type code of the URL type to the web browser.

Further, after setting a new URL type according to the webpage content of the URL, the method further comprises steps of: adding the new URL type to the preset type list to obtain an updated type list; and sending the updated type list to the web browser so as to cause the web browser to synchronize with and store the updated type list.

The method provided by the present embodiment improves the speed for searching for history records by acquiring a URL type according to a URL and notifying the URL type to a web browser so as to cause the web browser to classify and rank the history record corresponding to the URL in terms of the URL type, and thus it is possible to find quickly the URL to be accessed within a short time, accordingly saving time for the user and making it convenient for use by the user.

In order to set forth the method provided by the above embodiment one in further detail, the method provided by the embodiment will be described by taking the following embodiment two as an example in combination with the above content. The Embodiment 2 is described in detail in the following content.

### Embodiment Two

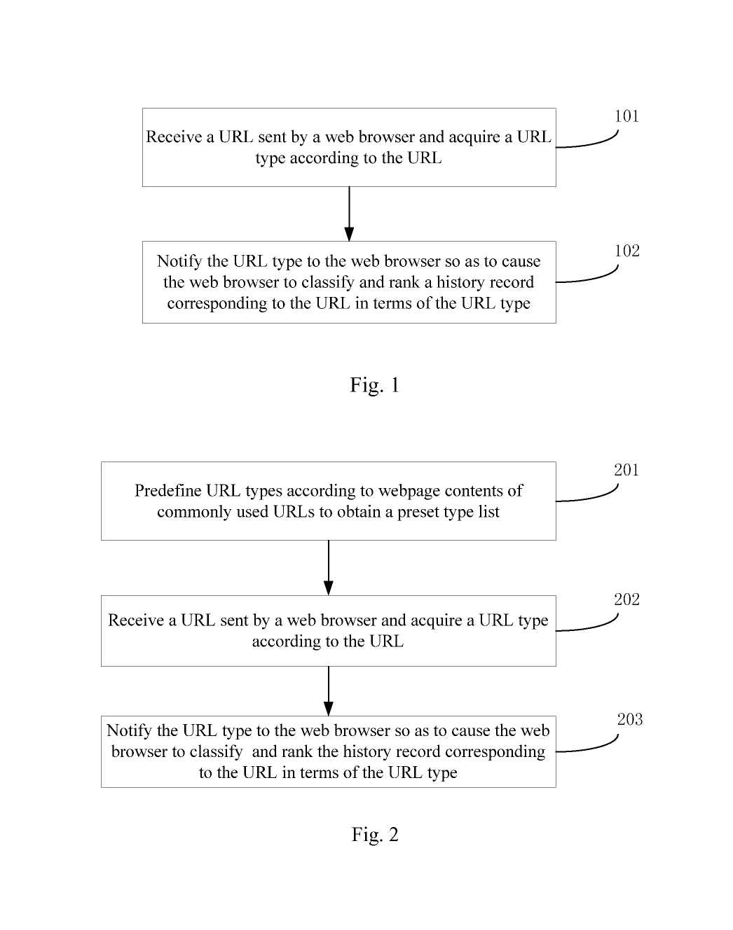

The embodiment of the present disclosure provides a history records sorting method, which acquires a URL type according to a URL and causes a web browser to rank the history record corresponding to the URL in terms of the URL type acquired by a history records sorting apparatus, whereby a problem of failing to searching for quickly the URL corresponding to a web site with a short access time length or a low access frequency in a short time is solved. For the convenience of explanation, the present embodiment describes the method provided by the embodiment in details by taking predefining URL types to obtain a preset type list and acquiring the URL type according to the preset type list as an example. Referring to FIG. 2, a flow for the history records sorting method is described in details in the following contents.

At step 201, predefine URL types according to webpage contents of commonly used URLs to obtain a preset type list.

Regarding this step, the way of predefining URL types according to webpage contents of commonly used URLs is not limited in the present embodiment. In a practical application, it is possible to classify webpage contents of commonly used URLs by an existing search engine to obtain corresponding URL types and accordingly a preset type list. Preferably, each URL type in the preset type list may correspond to a respective type code. In the embodiment, the type code is a way to specify a URL's type (namely the URL type), and may be indicated by digital numbers, such as “10,” “20” and like that. In another embodiment, the type code may be indicated by characters, or is consisted by digital numbers and characters. The following Table 1 shows an example of the preset type list.

TABLE 1

| URL type | Type code |
|---|---|
| Novel | 10 |
| Music | 20 |
| News | 30 |
| . . . | . . . |

Further, in the preset type list, each URL type may also includes one or more sub-URL types, and each sub-URL type corresponds to a respective sub-URL type code. With respect to this case, the preset type list may be as shown in Table 2 below.

TABLE 2

| URL type | Type code | Sub-URL type | Sub-URL type code |
|---|---|---|---|
| Novel | 10 | Romance | 101 |
| | | Martial arts | 102 |
| | | . . . | . . . |
| Music | 20 | Light music | 201 |
| | | Rock | 202 |
| | | . . . | . . . |
| News | 30 | Finance | 301 |
| | | Entertainment | 302 |
| | | . . . | . . . |
| . . . | . . . | . . . | . . . |

In addition to the contents in Tables 1 and 2, a preset type list may include other contents. The present embodiment does not limit contents in the preset type list obtained. In order for the web browser to be able to perform a type management on history records according to the preset type list, the step further includes, after obtaining the preset type list, a step of sending the preset type list to the web browser so as to cause the web browser to synchronize with and store the preset type list.

At step 202, receive a URL sent by the web browser, and acquire a URL type according to the URL.

Specifically, the URL sent by the web browser is the URL accessed by a user through the web browser, and the web browser recorded a history record corresponding to the URL. For example, the history record of the URL accessed by the user recorded by the web browser includes the URL, the title of the accessed webpage and the like. The present embodiment does not limit specific contents of the history record recorded by the web browser.

When acquiring the URL type according to the URL, it is also possible to acquire the URL type by a search engine. Likewise, the present embodiment does not limit the way of acquiring the URL type according to the URL. In a practical application, after obtaining the preset type list at the above step 201, the URL type may be obtained according to the URL by searching the preset type list, and the specific way thereof is as follows.

The webpage content of the URL is analyzed, and a matching is performed between the webpage content and URL types in the preset type list.

If a URL type in the preset type list matches with the webpage content, the URL type in the preset type list is determined as the URL type of the URL.

If none of URL types in the preset type list match with the webpage content, a new URL type is set according to the webpage content, and the new URL type is taken as the URL type of the URL.

For instance, the preset type list shown in the above Table 2 is taken as an example, and the URL accessed by the user and sent by the web browser is, for example, “www.xxx.mp3.com”. If it is determined by analyzing the webpage content corresponding to the URL that the webpage content of the URL is a music file in a mp3 format, it may be derived, after matching the webpage content with URL types in the preset type list, that the webpage content is matched with the URL type “Music” in the preset type list. Thus, the URL type “Music” may be sent to the web browser as the URL type of the URL “www.xxx.mp3.com”.

For another example, the preset type list shown in the above Table 2 is also taken as an example, and the URL accessed by the user and sent by the web browser is, for example, “www.yyy.mp3.com”. If it is determined by analyzing the webpage content corresponding to the URL that the webpage content of the URL is a video file, it may be found, after matching the webpage content with URL types in the preset type list, that there is no such a URL type related to “Video” in Table 2. Thus, a new URL type “Video” may be set according the webpage content as the URL type of the URL “www.yyy.video.com”.

Further, since the new URL type is set, in order to make URL types in the preset type list have broader coverage and are more informative, as well as to facilitate the next acquisition of the URL type corresponding to the URL according to the preset type list, the method provided by the present embodiment further includes, after setting the new URL type, the step of adding the new URL type to the preset type list to obtain an updated type list. Additionally, in order for the web browser to be able to update timely the type list synchronized to the web browser previously as well, the method provided by the embodiment further supports a step of sending the updated type list to the web browser so as to cause the web browser to synchronize with the updated type list.

At step 203, notify the web browser the acquired URL type and cause the web browser to classify and rank the history record corresponding to the URL in terms of the URL type.

With respect to this step, the present embodiment does not limit the way of notifying the acquired URL type to the web browser. Preferably, when the preset type list is obtained by predefining URL types at the above step 201, if URL types and type codes thereof are contained in the type list, the step may notify the type code of the URL type to the web browser while notifying the acquired URL type to the web browser. Since the web browser will synchronize with and store the preset type list and the type list updated later, the web browser may, after receiving the type code corresponding to the URL type, determine the URL type corresponding to the URL by searching the synchronized preset type list or updated type list, and classify and rank the history record corresponding to the URL in terms of the URL type.

For example, it is assumed that the URL type acquired at the above step 202 is “Novel”, the type code of the URL type is “10”, and the type code “10” is sent to the web browser. Accordingly, the web browser may determine the URL type corresponding to the type code is “Novel” by searching the synchronized type list, and arrange the history information corresponding to the URL under the type “Novel”.

Specifically, when classifying and ranking the history record corresponding to the URL in terms of the URL type, the web browser may record history records pertaining to a same type under one directory. In addition, when displaying history records of a same type by the web browser, the method provided by the present embodiment supports that the web browser makes statistics for the access time lengths and/or the access frequencies of respective web sites within a preset time, and ranks URLs corresponding to web sites according to the access time length and/or access frequency likewise.

For example, for every preset time period, the web browser makes statistics for access time lengths and/or access frequencies of URLs presented in parallel in each type during this preset time period, and ranks URLs of a same type in the collection according to the access time length and/or access frequency. When the user switches to a display page of history records, the web browser displays URLs classified and ranked. Such a method of ranking URLs of a same type in the collection according to access time length and/or access frequency is well known for those skilled in the art, and the detailed description thereof is omitted herein.

The method provided by the present embodiment improves the speed for searching for history records by acquiring a URL type according to a URL and notifying the URL type to a web browser so as to cause the web browser to classify and rank the history record corresponding to the URL in terms of the URL type, and thus it is possible to find quickly the URL to be accessed within a short time, accordingly saving time for the user and making it convenient for use by the user.

### Embodiment Three

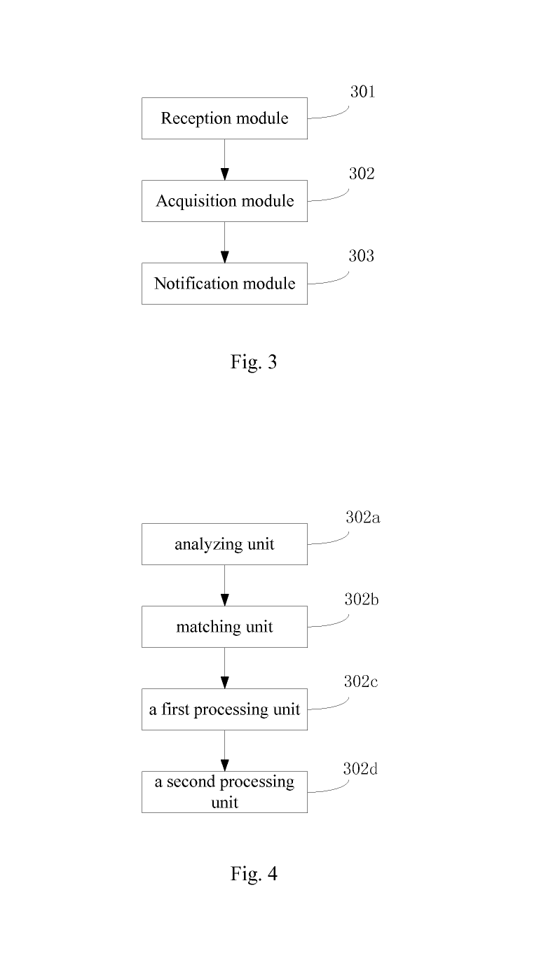

Referring to FIG. 3, a history records sorting apparatus is provided in the embodiment of the present disclosure. The apparatus includes a reception module 301 configured to receive a URL sent by a web browser, an acquisition module 302 configured to acquire a URL type according to the URL received by the reception module 301, and a notification module 303 configured to notify the URL type acquired by the acquisition module 302 to the web browser so as to cause the web browser to classify and rank the history records corresponding to the URLs according to the URL type.

Specifically, referring to FIG. 4, the acquisition module 302 includes a analyzing unit 302a configured to analyze the webpage content of the URL according to the URL received by the reception module 301, a matching unit 302b configured to match the webpage content analyzed by the analyzing unit 302a with URL types in a preset type list, a first processing unit 302c configured to, if the matching unit 302b derives that a URL type in the preset type list matches the webpage content analyzed by the analyzing unit, determine said URL type in the preset type list as the URL type of the URL, and a second processing unit 302d configured to set a new URL type according to the webpage content and take the new URL type as the URL type of the URL if the matching unit 302b derives that none of URL types in the preset type list match the webpage content analyzed by the analyzing unit.

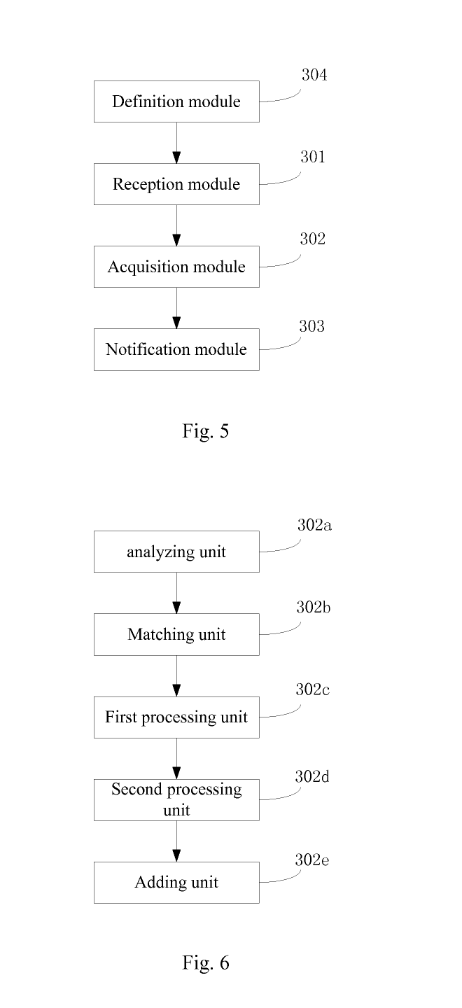

Further, referring to FIG. 5, the apparatus further includes a definition module 304 which is configured to predefine URL types according to webpage contents of commonly used URLs to obtain the preset type list. The notification module 303 is further configured to send the preset type list obtained by the definition module 304 to the web browser so as to cause the web browser to synchronize with the preset type list.

Each URL type in the preset type list corresponds to a respective type code. The notification module 303 is configured to notify the type code of the URL type to the web browser.

Further, referring to FIG. 6, the acquisition module 302 also includes an addition unit 302e which is configured to add the new URL type set by the second processing unit 302d to the preset type list to obtain the updated type list. The notification module 303 is further configured to send the updated type list obtained by the addition unit 302e to the web browser so as to cause the web browser to synchronize with the updated type list.

The apparatus provided by the present embodiment improves the speed for searching for history records by acquiring a URL type according to a URL and notifying the URL type to a web browser so as to cause the web browser to classify and rank the history record corresponding to the URL in terms of the URL type, and thus it is possible to find quickly the URL to be accessed within a short time, accordingly saving time for the user and making it convenient for use by the user.

According to an aspect of the present disclosure, a method for classifying and ranking a history record is provided. The method comprises: recording history records pertaining to a same URL type under one director, according to the URL types of URLs corresponding to respective history records; ranking the history records under one director according to access time lengths and/or access frequencies of respective web sites corresponding to the history records within a preset time.

According to another aspect of the present disclosure, an apparatus for classifying and ranking a history record is provided. The apparatus comprises: a classifying module configured to record history records pertaining to a same URL type under one director, according to the URL types of the URLs corresponding to respective history records; a ranking module configured to rank the history records under one director according to access time lengths and/or access frequencies of respective web sites corresponding to the history records within a preset time.

It is noted that the history records sorting apparatus provided in the above embodiment is illustrated by taking a division of respective functional modules as described above as an example when the web browser sorts history records. In a practical application, the above functions may be allocated to be achieved by different functional modules as needed, that is, the internal structure of the apparatus is divided into different functional modules to achieve all or part of functions as described above. Additionally, the history record apparatus provided by the above embodiment and the embodiment for the history records sorting method belong to a same concept, the specific implementation of the history record apparatus is referred to the method embodiment, and unnecessary details thereof are no longer given herein.

It is appreciated by those skilled in the art that all or part of steps for implementing the above embodiment may be achieved by hardware or by related hardware instructed by a program which may be stored in a computer readable storage medium that may be a read only memory, a magnetic disk, an optical disk and the like. Specifically, the computer readable storage medium may have a program recorded thereon, which is configured upon execution to sort history records through the steps of receiving a URL sent by a web browser and acquiring a URL type according to the URL; and notifying the URL type to the web browser so as to cause the web browser to classify and rank a history record corresponding to the URL in terms of the URL type.

The above descriptions are only embodiments of the present disclosure, and not for limiting the disclosure in any form. Although the present disclosure has been disclosed by embodiments as above, they are not used to limit the disclosure. Those skilled in the art may make use of the technical content disclosed above to make some changes or modify them into equivalent embodiments with equivalent changes without departing from the scope of technical schemes of the present disclosure. Any of simple varies, equivalent changes and modifications made to the above embodiments in accordance with the technical nature of the present disclosure without departing from contents of technical schemes of the present disclosure belong to the scope of technical schemes of the present disclosure.

### INDUSTRIAL APPLICABILITY

The present disclosure improves the speed for searching for history records by acquiring a URL type according to a URL and notifying the URL type to a web browser so as to cause the browser to classify and rank the history record corresponding to the URL in terms of the URL type, and thus it is possible to find quickly the URL to be accessed within a short time, accordingly saving time for the user and making it convenient for use by the user.

1. A history records sorting method, comprising:
receiving a URL sent by a web browser and acquiring a URL type according to the URL;
notifying the URL type to the web browser so as to cause the web browser to classify and rank a history record corresponding to the URL in terms of the URL type.

2. The history records sorting method according to claim 1, wherein said acquiring a URL type according to the URL comprises:
analyzing webpage content of the URL and matching the webpage content with URL types in a preset type list;
determining, if a URL type in the preset type list matches with the webpage content, the URL type in the preset type list matching with the webpage content as the URL type of the URL; and
setting a new URL type according to the webpage content and taking the new URL type as the URL type of the URL, if none of URL types in the preset type list match the webpage content.

3. The history records sorting method according to claim 2, before said acquiring a URL type according to the URL, further comprising:
predefining URL types according to webpage contents of commonly used URLs to obtain the preset type list;
sending the preset type list to the web browser so as to cause the web browser to synchronize with the preset type list.

4. The history records sorting method according to claim 2, wherein each URL type in the preset type list corresponds to a respective type code,
said notifying the URL type to the web browser comprises notifying the type code of the URL type to the web browser.

5. The history records sorting method according to claim 2, after said setting a new URL type according to the webpage content of the URL, further comprising:
adding the new URL type to the preset type list to obtain a updated type list; and
sending the updated type list to the web browser so as to cause the web browser to synchronize with the updated type list.

6. The history records sorting method according to claim 2, wherein each URL type further includes one or more sub-URL types, and each sub-URL type corresponds to a respective sub-URL type code.

7. A method for classifying and ranking a history record, comprising:
recording history records pertaining to a same URL type under one director, according to the URL types of URLs corresponding to respective history records;
ranking the history records under one director according to access time lengths and/or access frequencies of respective web sites corresponding to the history records within a preset time.

8. A history records sorting apparatus, comprising:
a reception module configured to receive a URL sent by a web browser;
an acquisition module configured to acquire a URL type according to the URL received by the reception module; and
a notification module configured to notify the URL type acquired by the acquisition module to the web browser so as to cause the web browser to classify and rank the history record corresponding to the URL in terms of the URL type.

9. The history records sorting apparatus according to claim 8, wherein said acquisition module comprises:
a analyzing unit configured to analyze webpage content of the URL according to the URL received by the reception module;
a matching unit configured to match the webpage content analyzed by the analyzing unit with URL types in a preset type list;
a first processing unit configured to, if the matching unit derives that a URL type in the preset type list matches with the webpage content analyzed by the analyzing unit, determine the URL type in the preset type list matching with the webpage content as the URL type of the URL; and
a second processing unit configured to, if the matching unit derives that none of URL types in the preset type list match the webpage content analyzed by the analyzing unit, set a new URL type according to the webpage content and take the new URL type as the URL type of the URL.

10. The history records sorting apparatus according to claim 9, further comprising:
a definition module configured to predefine URL types according to webpage contents of commonly URLs to obtain the preset type list,
wherein the notification module is further configured to send the preset type list obtained by the definition module to the web browser so as to cause the web browser to synchronize with the preset type list.

11. The history records sorting apparatus according to claim 9, wherein each URL type in the preset type list corresponds to a respective type code, and
the notification module is configured to notify the type code of the URL type to the web browser.

12. The history records sorting apparatus according to claim 9, wherein the acquisition module further comprises:
an adding unit configured to add the new URL type set by the second processing unit to the preset type list to obtain a updated type list, and
the notification module is further configured to send the updated type list obtained by the adding unit to the web browser so as to cause the web browser to synchronize with the updated type list.

13. The history records sorting method according to claim 9, wherein each URL type further includes one or more sub-URL types, and each sub-URL type corresponds to a respective sub-URL type code.

14. An apparatus for classifying and ranking a history record, comprising:
classifying module configured to record history records pertaining to a same URL type under one director, according to the URL types of the URLs corresponding to respective history records;
ranking module configured to rank the history records under one director according to access time lengths and/or access frequencies of respective web sites corresponding to the history records within a preset time.

15. A non-transitory computer readable storage medium having instructions stored thereon, the instructions, when executed by one or more processor, causing the one or more processors to perform operations comprising: receiving a URL sent by a web browser and acquiring a URL type according to the URL; notifying the URL type to the web browser so as to cause the web browser to classify and rank a history record corresponding to the URL in terms of the URL type.
